(19) United States
(12) Patent Application Publication
(10) Pub. No.: US 2024/0314585 A1
(43) Pub. Date: Sep. 19, 2024

(54) OPTIMIZING PERFORMANCE OF CUSTOMER PREMISES EQUIPMENT IN WIRELESS NETWORK

(71) Applicant: Samsung Electronics Co., Ltd., Suwon-si (KR)

(72) Inventors: Joseph THALIATH, Bangalore (IN); Jaijin LIM, Suwon-si (KR); Seungil YOON, Suwon-si (KR); Sukhdeep SINGH, Bangalore (IN); Sandeep Kumar JAISAWAL, Bangalore (IN)

(21) Appl. No.: 18/427,189

(22) Filed: Jan. 30, 2024

Related U.S. Application Data
(63) Continuation of application No. PCT/KR2024/000613, filed on Jan. 12, 2024.

(30) Foreign Application Priority Data
Mar. 16, 2023 (IN) 202341017820
Sep. 14, 2023 (IN) 202341017820

(51) Int. Cl. H04W 24/02; H04W 24/10

(52) U.S. Cl. CPC H04W 24/02; H04W 24/10

(57) ABSTRACT

Various embodiments herein achieve method for optimizing a performance of a customer premises equipment (CPE) in a wireless network by a network apparatus. The method includes receiving a measurement information from at least one CPE. Further, the method includes receiving a measurement information from at least one RAN node. Further, the method includes detecting whether a performance associated with at least one CPE is degraded based on the received measurement information from the at least one CPE. Further, the method includes identifying a RAN UE ID for the at least one CPE whose performance is degraded by correlating the measurement information received from the at least one CPE and the measurement information received from the at least one RAN node. Further, the method includes applying an action based on the identified RAN UE ID.

### CROSS REFERENCE TO RELATED APPLICATIONS

This application is a continuation of International Application No. PCT/KR2024/000613 designating the United States, filed on Jan. 12, 2024, in the Korean Intellectual Property Office and claiming priority to Indian Provisional Application No. 20/234,1017820, filed on Mar. 16, 2023, and to Indian Complete patent application Ser. No. 20/234,1017820, filed on Sep. 14, 2023 in the Indian Patent Office, the disclosures of each of which are incorporated by reference herein in their entireties.

### BACKGROUND

### Field

The disclosure relates to wireless communication networks, and for example, to methods and a network apparatus for optimizing a performance of a customer premises equipment (CPE) in the wireless network.

### Description of Related Art

In general, a fifth generation (5G) network deployments provide an increase in capacity and throughput. As part of the 5G deployments, a 5G fixed wireless access (FWA) provides an alternative to a fiber optic link connectivity to customer premises. Apart from using the 5G FWA (where fiber optic links are not feasible), the 5G FWA can also serve as an alternative where there are existing fiber optic links because of the increased reliability provided by multiple 5G access points. Despite the above gains mentioned for the 5G FWA, optimal performance gains can be achieved only if there is dynamic evaluation and optimization of radio connectivity for the 5G customer premise equipment's (CPEs). The first operation to perform dynamic optimization is to identify problems by analyzing key performance indicator (KPIs) obtained by a CPE management entity and a RAN management entity. The CPEs can be uniquely identified in the CPE management entity, but the same identification is not used by the RAN management entity. Hence in the second operation where actions by the RAN management entity need to be dynamically mitigated for a particular CPE to rectify the problem is not possible.

FIG. 1 is a diagram illustrating an example scenario (100) in which a RAN mitigation action triggered for the CPE (102a-102n)/a user equipment (UE) based on a common RAN degradation criteria and not per CPE service level agreement (SLA), according to the prior art.

In this scenario, a SLA is configured for each CPE (102a-102n) in the CPE management entity (104). The CPE management entity (104) monitors the KPIs received from each CPE (102a-102n) and detect SLA violations. RAN nodes (e.g., radio unit (RU) node/distributed unit (DU) (106), FWA GW (108), CU-user plane (CU-UP) (110), a user plane function (UPF) entity (112), a CU-CP (114), a near-real time RAN control entity (114) or the like) may also monitor RAN KPIs for the CPE acting as the UE and if degradation is detected (not based on the SLA configured in the CPE management entity (104), but based on default RAN criteria's. The RU/DU node (106) is coupled with the FWA GW (108), the CU-UP (110), the UPF entity (112), the CU-CP (114), and the near-real time RAN control entity (114). The degradation will take mitigation actions. The CPE SLA information is not shared with the RAN node and hence the mitigation actions are not taken based on the SLA violations configured in the CPE management entity (104). The existing method will prevent timely mitigation action to provide the agreed CPE SLA.

FIG. 2 is a diagram illustrating an example scenario (200) in which the CPE degradation is identified and may trigger a RAN mitigation action but the RAN cannot identify the CPE (102a-102n) for which mitigation is required, according to the prior art.

In this scenario, the SLA is configured for each CPE (102a-102n) in the CPE management entity (104) and the SLA may be provided to the FWA analytics engine (202). The FWA analytics engine (202) monitors the KPIs received from the CPE and detects the SLA violations. The FWA analytics engine (202) also has connectivity to the RAN node to take mitigation actions and collect RAN KPIs. Based on the KPIs collected from the CPE management entity, the RAN nodes may take mitigation actions at a RAN or cell level. The FWA analytics engine (202) may take mitigation action at the RAN/cell level and cannot take mitigation action at the CPE/UE level. The FWA analytics engine (202) cannot map the SLA degradation identified for the CPE (102a-102n) to the CPE acting as the UE towards the RAN nodes. Hence, the per CPE SLA is not met which degrade the performance of CPE and users attached to it.

In an example, as shown in FIG. 2, the FWA analytics engine (202) identifies CPE ID Y is having a problem based on the CPE SLA. But, the FWA analytics engine (202) unable to map the CPE ID Y to the RAN UE ID A. in general, corresponding RAN UE ID is required to trigger mitigation action in the RAN domain. The CPE degradation is identified and may trigger RAN mitigation action but the RAN cannot identify the CPE for which mitigation is required. It may trigger mitigation at the cell level. Hence, based on the existing methods, the per CPE SLA is not met which degrade the performance of CPE and users attached to it.

FIG. 3 is a diagram illustrating an example scenario (300) in which RAN mitigation action triggered for the CPE/UEs (102a-102n) based on a reactive approach (e.g., CPE SLA assurance based prediction approach or the like), according to the prior art.

In this scenario, traffic prediction models for each CPE (102a-102n) may be created in the CPE management entity (104). The CPE management entity (104) monitors the KPIs received from the CPE (102a-102n). Based on the per CPE KPIs, the CPE management entity (104) may train models and create traffic prediction models for each CPE (102a-102n). The RAN nodes may also monitor RAN KPIs for the CPE acting as the UE and if degradation is detected (not based on prediction models stored in the CPE management entity (104) but based on default RAN criteria's), it will take mitigation actions.

In the existing methods, the traffic prediction models for each CPE are not shared with the RAN and hence mitigation actions are not taken based on the traffic predictions. The RAN cannot create long term traffic prediction models for the CPE/UE because of the mobility possibility for the CPE/UE and the RAN only stores temporary identifiers for the CPE/UE. This will prevent timely mitigation action to provide the agreed CPE SLA.

FIG. 4 is a diagram illustrating an example scenario (400) in which CPE/UE degradation is identified in the RAN and the FWA analytics engine (202) may provide CPE prediction models/predictions to assist the RAN mitigation action but RAN will be unable to map it to the RAN UE ID and will not be able to use the predictions for the mitigation actions, according to the prior art;

The FWA analytics engine (202) monitors the KPIs received from the CPE and detects the SLA violations. The traffic prediction models for each CPE may be created in the FWA analytics engine (202) based on the collected KPIs. The FWA analytics engine (202) also has connectivity to the RAN nodes to take mitigation actions and collect RAN KPIs. The RAN nodes may also monitor RAN KPIs for the CPE (102a-102n) acting as the UE and if the degradation is detected (not based on prediction models stored in the CPE management but based on default RAN criteria's), it will take mitigation actions.

The CPE/UE degradation is identified in the RAN node and the FWA analytics engine (202) may provide the CPE prediction models/predictions to assist the RAN mitigation action but RAN will be unable to map the prediction models/prediction to a particular RAN UE ID and will not be able to use the predictions for the mitigation actions. This will prevent timely mitigation action to provide the agreed CPE SLA.

It is desired to address the above mentioned disadvantages and/or other short comings or at least provide a useful alternative.

### SUMMARY

Embodiments of the disclosure disclose methods and a network apparatus for optimizing a performance of a customer premises equipment (CPE) in a wireless network (e.g., 5G network, sixth generation (6G) network, open radio access network (ORAN) or the like).

Embodiments of the disclosure disclosed methods and apparatus to uniquely identify CPEs for performing a RAN triggered controls by correlating key performance indicator's (KPIs) measured by a CPE management entity and RAN management entity.

Embodiments of the disclosure may identify right CPEs within a RAN domain to apply corresponding mitigation actions triggered by the RAN by correlating KPIs measured by the CPE management entity and the RAN management entity.

Embodiments of the disclosure provide a RAN mitigation action that is triggered for the CPE/UE based on per CPE SLA rather than common RAN degradation criteria which may help to meet per CPE SLA and corresponding users attached to it.

Embodiments of the disclosure provide the RAN mitigation actions that are triggered for the CPE/UEs may be done on prevention/reduction basis before the problem actually happens rather than reactive basis. The services provided to users attached to CPEs may be protected from any degradation.

Embodiments of the disclosure identify a CPE degradation that may trigger RAN mitigation action by identifying the CPE for which mitigation is required. This helps to meet a quality of service (QoS)/quality of experience (QoE) of the particular CPE along with its respective SLAs.

Embodiments of the disclosure identify the CPE/UE degradation in the RAN node and the FWA analytics engine that may provide CPE prediction models/predictions to assist the RAN mitigation action. Also, the RAN will be able to map it to a RAN UE ID and will be able to use the predictions for the mitigation actions which may help us to meet per CPE SLA and corresponding users attached to it.

Example embodiments of the disclosure provide methods for optimizing a performance of a CPE in a wireless network. The method may include receiving, by a network apparatus, first measurement information from at least one customer premises equipment (CPE). The method may include receiving, by the network apparatus, second measurement information from at least one RAN node. The method may include detecting, by the network apparatus, whether a performance associated with at least one CPE is degraded based on the first measurement information. The method may include identifying, by the network apparatus, a RAN user equipment identifier (UE ID) for the at least one CPE whose performance is degraded by correlating the first measurement information and the second measurement information. The method may include applying, by the network apparatus, an action based on the identified RAN UE ID.

In an example embodiment, the action includes at least one of a forced handover of the CPE to a less loaded cell in the RAN node having a connectivity with sufficient signal strength towards the at least one CPE, a throughput enhancement, and a traffic reduction.

In an example embodiment, each of the first measurement information and the second measurement information includes at least one of a latency, a reference signal received power (RSRP), a signal to interference noise ratio (SINR), a reference signal received quality. (RSRQ), a channel quality indicator (CQI), throughput, and a received signal strength indicator (RSSI).

In an example embodiment, correlating, by the network apparatus, the first measurement information and the second measurement information: correlating the first measurement information comprising at least one key performance indicator (KPI) and the second measurement information comprising at least one KPI, and dynamically creating a mapping between the first measurement information comprising the at least one KPI and the second measurement information comprising the at least one KPI.

In an example embodiment, the first measurement information and the second measurement information are correlated using a correlation technique. The correlation technique includes a Pearson correlation technique, Spearman correlation technique, Kendal-Tau correlation technique and dynamic time warping (DTW) technique.

In an example embodiment, a CPE ID to the RAN UE ID mapping is created and updated in a periodic manner over an offline mode.

In an example embodiment, the network apparatus provides at least one CPE prediction model to assist for applying the action based on the identified RAN UE ID.

Accordingly, various example embodiments herein provide a network apparatus including a CPE performance controller comprising circuitry coupled with at least one processor and a memory. The CPE performance controller is configured to receive first measurement information from at least one CPE. The CPE performance controller is configured to receive second measurement information from at least one RAN node. The CPE performance controller is configured to detect whether a performance associated with at least one CPE is degraded based on the first measurement information. The CPE performance controller is configured to identify a RAN UE ID for the at least one CPE whose performance is degraded by correlating the first measurement information and the second measurement information. The CPE performance controller is configured to apply an action based on the identified RAN UE ID.

In accordance with another aspect of the disclosure, one or more non-transitory computer-readable storage media storing computer-executable instructions are provided. The instructions, when executed by at least one processor of a network apparatus, cause the network apparatus to perform operations, the operations including receiving, by a network apparatus, first measurement information from at least one customer premises equipment (CPE), receiving, by the network apparatus, second measurement information from at least one radio access node (RAN) node, detecting, by the network apparatus, whether a performance associated with at least one CPE is degraded based on the first measurement information, identifying, by the network apparatus, a RAN user equipment identifier (UE ID) for the at least one CPE whose performance is degraded by correlating the first measurement information received and the second measurement information, and applying, by the network apparatus, an action based on the identified RAN UE ID. These and other aspects of the various example embodiments herein will be better appreciated and understood when considered in conjunction with the following description and the accompanying drawings. It should be understood, however, the following descriptions, while indicating various example embodiments and numerous specific details thereof, are given by way of illustration and not of limitation. Many changes and modifications may be made within the scope of the disclosure herein without departing from the spirit thereof, and the embodiments herein include all such modifications.

### BRIEF DESCRIPTION OF THE DRAWINGS

The various example embodiments disclosed herein are illustrated in the accompanying drawings, throughout which like reference letters refer to like parts in the various figures. The above and other aspects, features and advantages of certain embodiments of the disclosure will be more apparent from the following detailed description taken in conjunction with the accompanying drawings, in which:

FIG. 1 is a diagram illustrating an example scenario in which a RAN mitigation action triggered for a CPE/UE based on a common RAN degradation criteria and not per CPE SLA, according to the prior art;

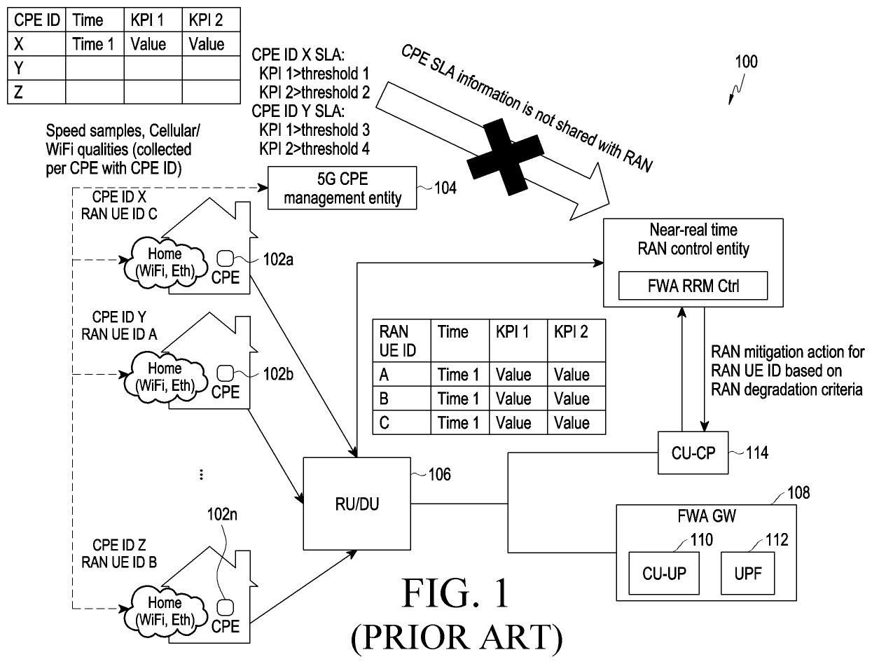

FIG. 2 is a diagram illustrating an example scenario in which a CPE degradation is identified and may trigger a RAN mitigation action but a RAN cannot identify the CPE for which mitigation is required, according to the prior art;

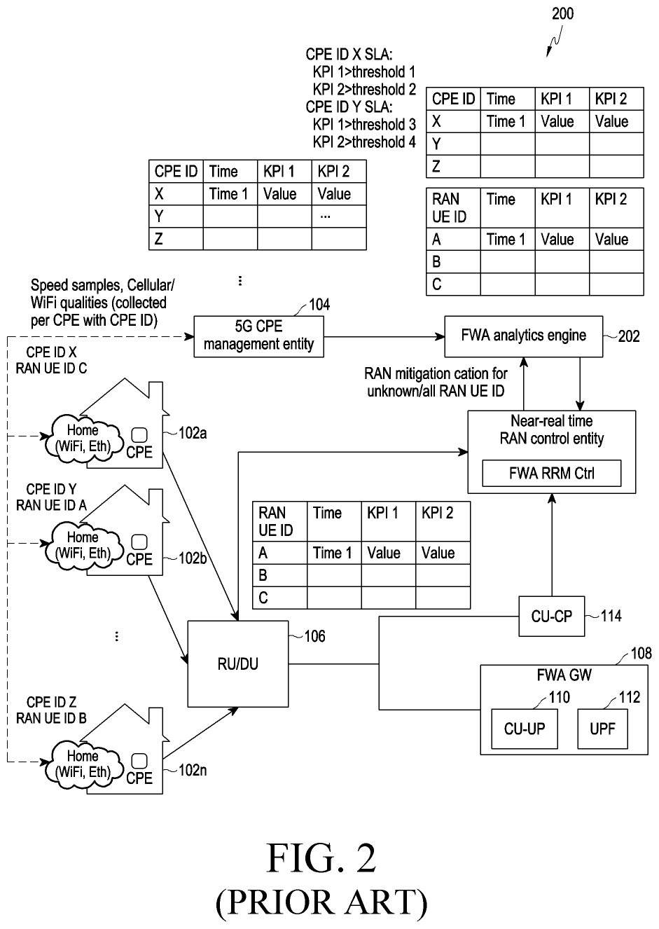

FIG. 3 is a diagram illustrating an example scenario in which a RAN mitigation action triggered for the CPE/UEs based on a reactive approach, according to the prior art;

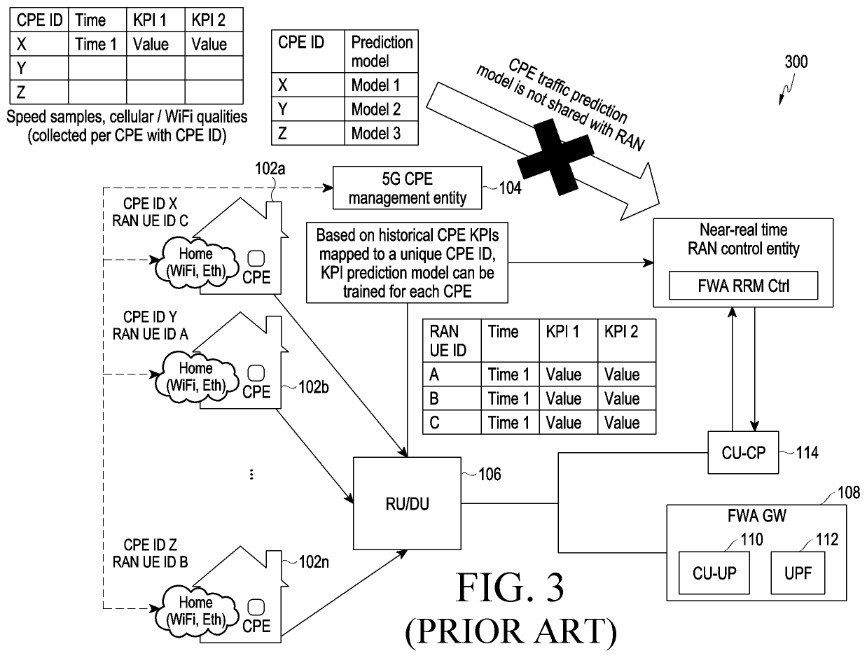

FIG. 4 is a diagram illustrating an example scenario in which the CPE/UE degradation is identified in the RAN and a FWA analytics may provide CPE prediction models/predictions to assist a RAN mitigation action but the RAN will be unable to map it to a RAN UE ID and will not be able to use the predictions for the mitigation actions, according to the prior art;

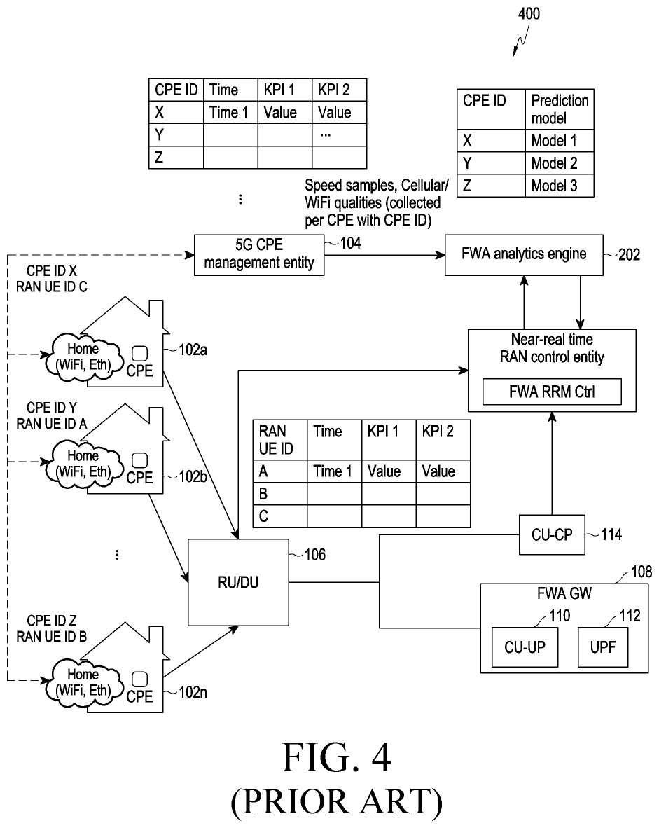

FIG. 5 is a block diagram illustrating various hardware components of a network apparatus, according to various embodiments of the disclosure;

FIG. 6 is a flowchart illustrating an example method for optimizing a performance of the CPE in a wireless network, according to various embodiments of the disclosure;

FIG. 7 is a diagram illustrating an example periodic offline processing loop for creating and updating a CPE ID to a RAN UE ID, according to various embodiments of the disclosure;

FIG. 8 is a sequence diagram illustrating an example periodic offline processing loop for creating and updating the CPE ID to the RAN UE ID, according to various embodiments of the disclosure;

FIG. 9 is a diagram illustrating an online processing loop for detecting anomaly and providing the RAN UE ID for a mitigation action, according to various embodiments of the disclosure;

FIG. 10 is a sequence diagram illustrating an example online processing loop for detecting the anomaly and providing the RAN UE ID for the mitigation action, according to various embodiments of the disclosure;

FIG. 11 is a diagram illustrating an example scenario in which KPI and measurement details are depicted, according to various embodiments of the disclosure;

FIG. 12 is a diagram illustrating an example scenario in which the network apparatus optimizes the performance of the CPE in the wireless network during a forced handover, according to various embodiments of the disclosure;

FIG. 13 is a block diagram illustrating an example scenario in which the network apparatus optimizes the performance of the CPE in a non O-RAN deployment, according to various embodiments of the disclosure;

FIG. 14 is a block diagram illustrating an example scenario in which the network apparatus optimizes the performance of the CPE in a O-RAN deployment, according to various embodiments of the disclosure; and

FIG. 15 is a diagram illustrating an example scenario in which the network apparatus optimizes the performance of the CPE in the wireless network, according to various embodiments of the disclosure.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques may be omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the disclosure.

For the purposes of interpreting this disclosure, the definitions (as defined herein) will apply and whenever appropriate the terms used in singular will also include the plural and vice versa. It is to be understood that the terminology used herein is for the purposes of describing various embodiments only and is not intended to be limiting. The terms “comprising”, “having” and “including” are to be understood as open-ended terms unless otherwise noted.

The words/phrases “exemplary”, “example”, “illustration”, “in an instance”, “and the like”, “and so on”, “etc.”, “etcetera”, “e.g.,”, “i.e.,” are merely used herein to refer, for example, to “serving as an example, instance, or illustration.” Any embodiment or implementation of the present subject matter described herein using the words/phrases “exemplary”, “example”, “illustration”, “in an instance”, “and the like”, “and so on”, “etc.”, “etcetera”, “e.g.,”, “i.e.,” is not necessarily to be construed as preferred or advantageous over any other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits of a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the steps or operations required for understanding of aspects of the embodiments as disclosed herein. Furthermore, in terms of the construction of the device, one or more components of the device may have been represented in the drawings by conventional symbols, and the drawings may show only those specific details that are pertinent to understanding the various embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the disclosure should be construed to extend to any modifications, equivalents, and substitutes in addition to those which are particularly set out in the accompanying drawings and the corresponding description. Usage of words such as first, second, third etc., to describe components/elements/steps/operations is for the purposes of this description and should not be construed as sequential ordering/placement/occurrence unless specified otherwise.

The embodiments herein achieve methods for optimizing a performance of a CPE in a wireless network. The method includes receiving, by a network apparatus, a measurement information from at least one CPE. Further, the method includes receiving, by the network apparatus, a measurement information from at least one RAN node. Further, the method includes detecting, by the network apparatus, whether a performance associated with at least one CPE is degraded based on the received measurement information from the at least one CPE. Further, the method includes identifying, by the network apparatus, a RAN UE ID for the at least one CPE whose performance is degraded by correlating the measurement information received from the at least one CPE and the measurement information received from the at least one RAN node. Further, the method includes applying, by the network apparatus, an action based on the identified RAN UE ID.

The disclosed method may be used for identifying the right CPEs within the RAN domain to apply the corresponding mitigation actions triggered by the RAN by correlating KPIs measured by a CPE management entity and a RAN management entity. The disclosed method allows a network operator to identify the candidate cells and CPEs for further investigation, either in a cell-wise manner or a CPE-wise manner. The method allows the network operator to identify the candidate cells and CPEs for further investigation, either by finding cell-level anomalies or by finding CPE-level anomalies.

Based on the disclosed method, the RAN mitigation action is triggered for the CPE/UE based on per the CPE SLA rather than common RAN degradation criteria which may help us to meet per CPE SLA and corresponding users attached to it. The RAN mitigation actions that are triggered for the CPE/UEs may be done on prevention/reduction basis before the problem actually happens rather than reactive basis. The services provided to users attached to the CPEs may be protected from any degradation. The CPE degradation is identified may trigger RAN mitigation action by identifying the CPE for which mitigation is required. This helps to meet the QoS/QoE of the particular CPE along with its respective SLAs. The CPE/UE degradation is identified in RAN and FWA analytics may provide CPE prediction models/predictions to assist the RAN mitigation action. Also, RAN will be able to map it to a RAN UE ID and will be able to use the predictions for the mitigation actions which may help us to meet per CPE SLA and corresponding users attached to it.

In an example, consider, the 5G CPEs are deployed in customer premises. From the CPE management entity, the CPE related KPIs with globally unique IDs may be used to detect or predict CPE functional or performance problems. For mitigation actions to be triggered from the RAN entity, corresponding CPEs need to identified in RAN using RAN specific identities.

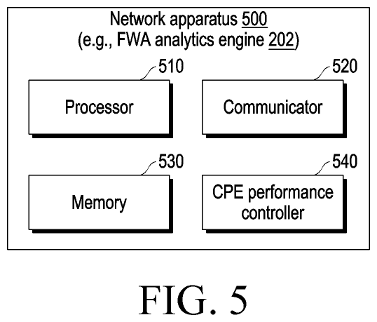

Referring now to the drawings, and more particularly to FIGS. 5 through 15, where similar reference characters denote corresponding features consistently throughout the figures, there are shown various example embodiments.

FIG. 5 is a block diagram illustrating various hardware components of a network apparatus (500), according to various embodiments. The network apparatus (500) may be a fixed wireless access (FWA) analytics engine (202). In an embodiment, the network apparatus (100) includes a processor (e.g., including processing circuitry) (510), a communicator (e.g., including communication circuitry) (520), a memory (530) and a CPE performance controller (e.g., including various circuitry) (540). The processor (510) is coupled with the communicator (520), the memory (530) and the CPE performance controller (540) (e.g., FWA anomaly detection controller 540a).

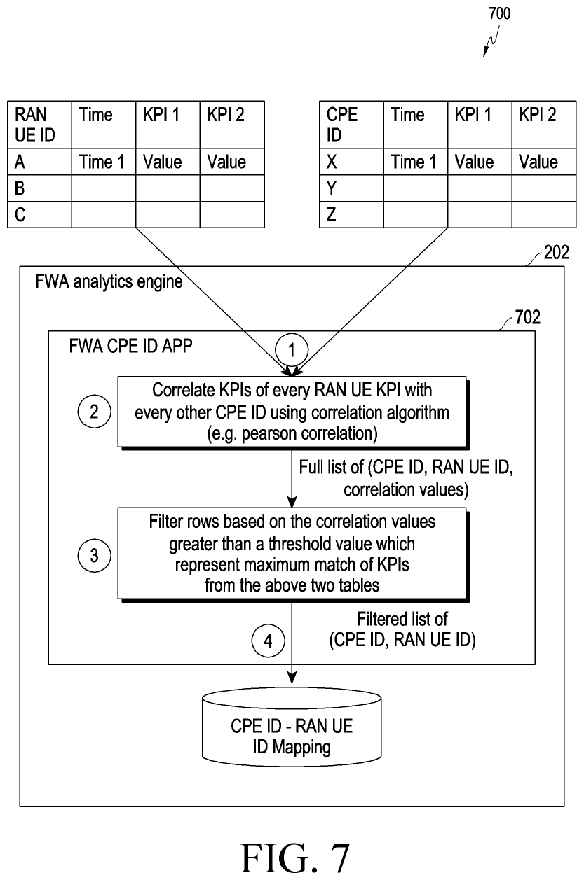

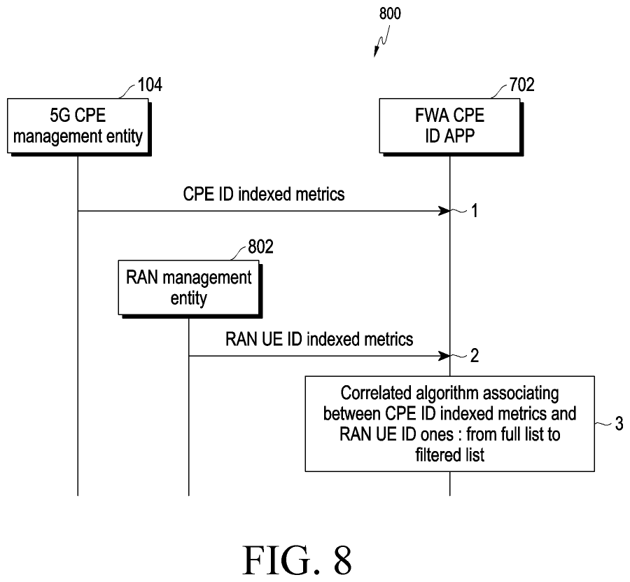

The CPE performance controller (540) may include various processing and/or control circuitry. For example, as used herein, including the claims, the term “processor” and/or controller may include various processing circuitry, including at least one processor, wherein one or more processors of at least one processor may be configured to perform the various functions described herein. Additionally, the at least one processor may include a combination of processors performing various of the recited/disclosed functions. The CPE performance controller (540) may include various processing circuitry and receives a measurement information from a CPE (e.g., telephone handsets, cable TV set-top boxes, Digital Subscriber Line (DSL) routers, or the like). Further, the CPE performance controller (540) receives a measurement information from a radio access node (RAN) node. The measurement information may be, for example, but not limited to a latency, a RSRP, a SINR, a RSRQ, a CQI, throughput, and a RSSI. Further, the CPE performance controller (540) detects whether a performance associated with the CPE (102a-102n) is degraded based on the received measurement information from the CPE (102a-102n). Further, the CPE performance controller (540) identifies a RAN UE ID for the CPE whose performance is degraded by correlating the measurement information received from the CPE (102a-102n) and the measurement information received from the RAN node. A CPE ID to the RAN UE ID mapping is created and updated in a periodic manner over an offline mode (explained in FIG. 7 and FIG. 8). Based on the identified RAN UE ID, the CPE performance controller (540) applies an action. The action may be, for example, but not limited to a forced handover of the CPE (102a-102n) to a less loaded cell in the RAN node which have good connectivity with sufficient signal strength towards the CPE (102a-102n), a throughput enhancement, and a traffic reduction. The CPE performance controller (540) provides a CPE prediction model to assist for applying the action based on the identified RAN UE ID.

In an embodiment, the measurement information received from the CPE (102a-102n) and the measurement information received from RAN node is correlated by correlating the measurement information including a KPI received from the CPE and the measurement information including the KPI received from the RAN node, and dynamically creating a mapping between the measurement information including the KPI received from the CPE (102a-102n) and the measurement information including the KPI received from the RAN node.

In an embodiment, the measurement information received from the CPE and the measurement information received from the RAN node is correlated using a correlation technique. The correlation technique may be, for example, but not limited to a Pearson correlation technique, Spearman correlation technique, Kendal-Tau correlation technique, dynamic time warping (DTW) technique, or the like.

The CPE performance controller (540) may be physically implemented by analog or digital circuits such as logic gates, integrated circuits, microprocessors, microcontrollers, memory circuits, passive electronic components, active electronic components, optical components, hardwired circuits, or the like, and may optionally be driven by firmware.

Further, the processor (510) may include various processing circuitry. For example, as used herein, including the claims, the term “processor” may include various processing circuitry, including at least one processor, wherein one or more processors of at least one processor may be configured to perform the various functions described herein. Additionally, the at least one processor may include a combination of processors performing various of the recited/disclosed functions. The processor (510) may be configured to execute instructions stored in the memory (530) and to perform various processes. Various applications (e.g., FWA CPE ID application (702) (as shown in FIG. 7) or the like) are stored in the memory (530).

The communicator (520) may include various communication circuitry and is configured for communicating internally between internal hardware components and with external devices via one or more networks. The memory (530) also stores instructions to be executed by the processor (510). The memory (530) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (530) may, in some examples, be considered a non-transitory storage medium. The term “non-transitory” may indicate that the storage medium is not embodied in a carrier wave or a propagated signal. However, the term “non-transitory” should not be interpreted that the memory (530) is non-movable. In certain examples, a non-transitory storage medium may store data that can, over time, change (e.g., in random access memory (RAM) or cache).

Further, at least one of the plurality of modules/controller may be implemented through an AI/machine learning (ML) model using a data driven controller (not shown). The data driven controller may be a ML model based controller and AI model based controller. A function associated with the AI model may be performed through the non-volatile memory, the volatile memory, and the processor (510). The processor (510) may include one or a plurality of processors. At this time, one or a plurality of processors may be a general purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU).

The one or more processors may control the processing of the input data in accordance with a predefined operating rule or AI model stored in the non-volatile memory and the volatile memory. The predefined operating rule or artificial intelligence model is provided through training or learning.

Here, being provided through learning may refer, for example, to a predefined operating rule or AI model of a desired characteristic is made by applying a learning algorithm to a plurality of learning data. The learning may be performed in a device itself in which AI according to an embodiment is performed, and/o may be implemented through a separate server/system.

The AI model may include of a plurality of neural network layers. Each layer has a plurality of weight values, and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning algorithm is a method for training a predetermined target device (for example, a robot) using a plurality of learning data to cause, allow, or control the target device to make a determination or prediction. Examples of learning algorithms include, but are not limited to, supervised learning, unsupervised learning, semi-supervised learning, or reinforcement learning.

Although FIG. 5 shows various hardware components of the network apparatus (500) it is to be understood that other embodiments are not limited thereto. In other embodiments, the network apparatus (500) may include less or more number of components. Further, the labels or names of the components are used only for illustrative purpose and does not limit the scope of the disclosure. One or more components may be combined together to perform same or substantially similar function in the network apparatus (500).

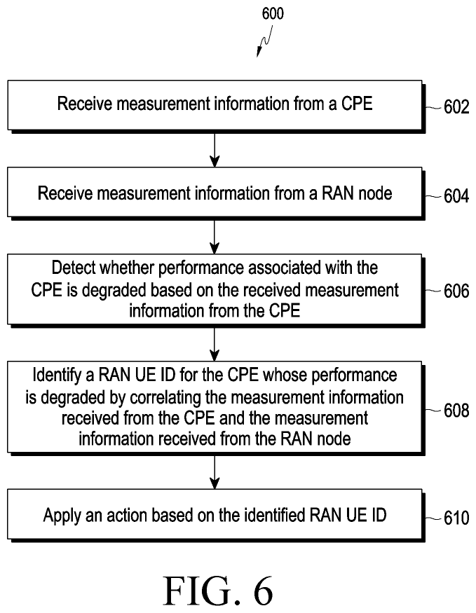

FIG. 6 is a flowchart (600) illustrating an example method for optimizing the performance of the CPE (102a-102n) in the wireless network, according to various embodiments. The wireless network may be, for example, but is not limited to the 5G network, a 6G network, an ORAN or the like. The operations (602-610) may be performed, for example, by the CPE performance controller (540).

At 602, the method includes receiving measurement information from the CPE (102a-102n). At 604, the method includes receiving the measurement information from the RAN node. At 606, the method includes detecting whether the performance associated with the CPE (102a-102n) is degraded based on the received measurement information from the CPE (102a-102n). At 608, the method includes identifying the RAN UE ID for the CPE (102a-102n) whose performance is degraded by correlating the measurement information received from the CPE (102a-102n) and the measurement information received from the RAN node. At 610, the method includes applying the action based on the identified RAN UE ID. The action may be, for example, but not limited to the forced handover of the CPE (102a-102n) to the less loaded cell in the RAN node which have good connectivity with sufficient signal strength towards the CPE (102a-102n), the throughput enhancement, and the traffic reduction.

The method may be used for identifying the right CPEs within the RAN domain to apply the corresponding mitigation actions triggered by the RAN by correlating KPIs measured by the CPE management entity and the RAN management entity.

Based on the example methods, the RAN mitigation action that is triggered for CPE/UE based on per CPE SLA rather than common RAN degradation criteria which may help us to meet per CPE SLA and corresponding users attached to it. The RAN mitigation actions that are triggered for CPE/UEs may be done on a prevention/reduction basis before the problem actually happens rather than on a reactive basis. The services provided to users attached to CPEs may be protected from any degradation. The CPE degradation is identified may trigger RAN mitigation action by identifying the CPE for which mitigation is required. This helps to meet the QoS/QoE of the particular CPE along with its respective SLAs. The CPE/UE degradation is identified in RAN and FWA analytics may provide CPE prediction models/predictions to assist the RAN mitigation action. Also, RAN will be able to map it to a RAN UE ID and will be able to use the predictions for the mitigation actions which may help us to meet per CPE SLA and corresponding users attached to it.

The method allows the network operator to identify the candidate cells and CPEs for further investigation, either in a cell-wise manner or a CPE-wise manner. The method allows the network operator to identify the candidate cells and CPEs for further investigation, either by finding cell-level anomalies or by finding CPE-level anomalies.

The various actions, acts, blocks, steps, operations, or the like in the flow chart (600) may be performed in the order presented, in a different order or simultaneously. Further, in various embodiments, some of the actions, acts, blocks, steps, operations, or the like may be omitted, added, modified, skipped, or the like without departing from the scope of the disclosure.

FIG. 7 is a diagram illustrating an example periodic offline processing loop (700) for creating and updating the CPE ID to the RAN UE ID, according to various embodiments. At operation 1, the FWA analytics engine (202) receives the RAN UE KPI and the CPE ID. At operation 2, after receiving the RAN UE KPI and the CPE ID, the FWA analytics engine (202) correlates the KPIs of every RAN UE KPI with every other CPE ID using the correlation technique (e.g. Pearson correlation technique). The FWA analytics engine (202) stores the full list of CPE ID, the RAN UE ID, and the correlation values in the memory (530). At operation 3, the FWA analytics engine (202) filter rows based on the correlation values greater than the threshold value which represent maximum match of KPIs from the stored tables (as shown in FIG. 7). The FWA analytics engine (202) stores the filtered list of the CPE ID and the RAN UE ID. At operation 4, further, the FWA analytics engine (202) maps the CPE ID with the RAN UE ID.

FIG. 8 is a signal flow diagram (800) illustrating an example periodic offline processing loop for creating and updating the CPE ID to RAN UE ID, according to various embodiments. At operation 1, the FWA CPE ID application (APP) (702) receives the CPE ID indexed metrics from the CPE management entity (104). At operation 2, the FWA CPE ID APP (702) receives the RAN UE ID indexed Metrics from the RAN management entity (802). At operation 3, the FWA CPE ID APP (702) uses a correlated technique for associating the CPE ID indexed metrics and the RAN UE ID indexed metrics.

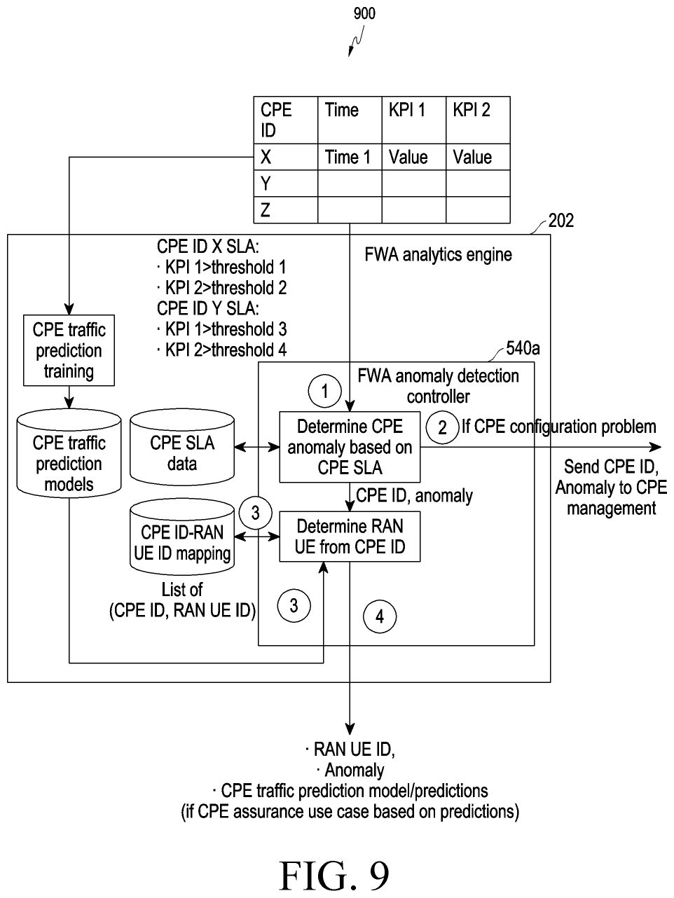

FIG. 9 is a diagram illustrating an online processing loop (900) for detecting anomaly and providing the RAN UE ID for mitigation action, according to various embodiments. At operation 1, the FWA analytics engine (202) determines the CPE anomaly based on the CPE SLA. At operation 2, based on determining the CPE configuration problem, the FWA analytics engine (202) sends the CPE ID and the anomaly to the CPE management entity (104). At operation 3, the FWA analytics engine (202) maps the CPE ID and RAN UE ID and determines the RAN UE from the CPE ID. Based on the mapping the CPE ID and the RAN UE ID, at operation 4, the FWA analytics engine (202) detects the anomaly and provides the RAN UE ID for the mitigation action.

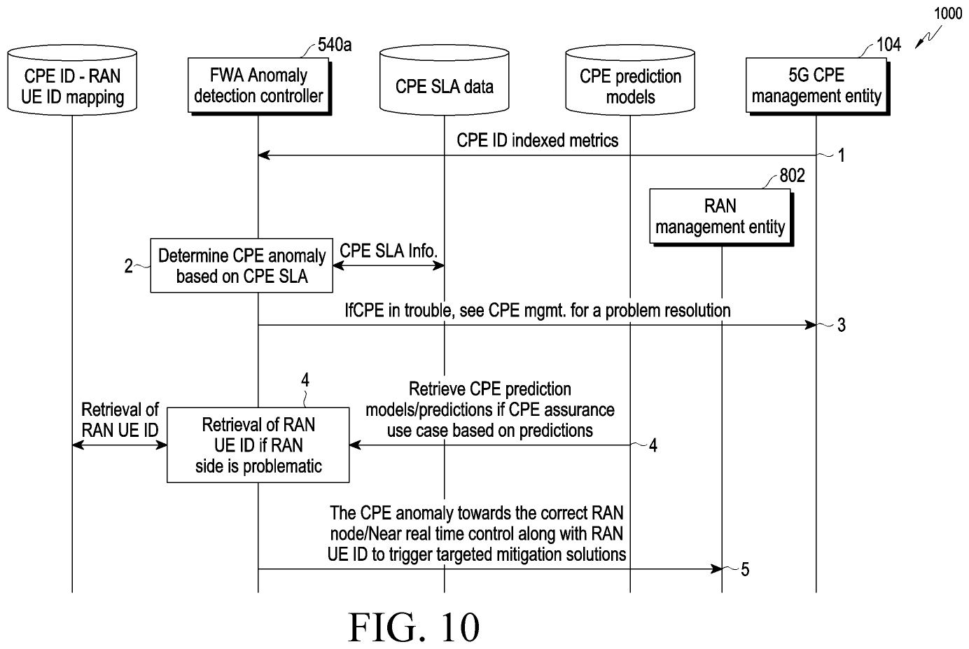

FIG. 10 is a signal flow diagram (1000) illustrating an online processing loop for detecting anomaly and providing RAN UE ID for mitigation action, according to various embodiments. At operation 1, the FWA anomaly detection controller (540a) receives the CPE ID indexed metrics from the CPE management entity (104). At operation 2, the FWA anomaly detection controller (540a) determines the CPE anomaly based on the CPE SLA. At operation 3, the FWA anomaly detection controller (540a) determines that the CPE (102a-102n) is in problem then, the FWA anomaly detection controller (540a) sends the CPE ID, and the anomaly to the CPE management entity.

At operation 4, the FWA anomaly detection controller (540a) retrieves the RAN UE ID upon determining the RAN side is problematic. The FWA anomaly detection controller (540a) retrieves the CPE prediction models/predictions. The FWA anomaly detection controller (540a) determines the retrieval of the RAN UE ID. At operation 5, the FWA anomaly detection controller (540a) sends the CPE anomaly towards the correct RAN node or the near real time control along with RAN UE ID to trigger targeted mitigation solutions.

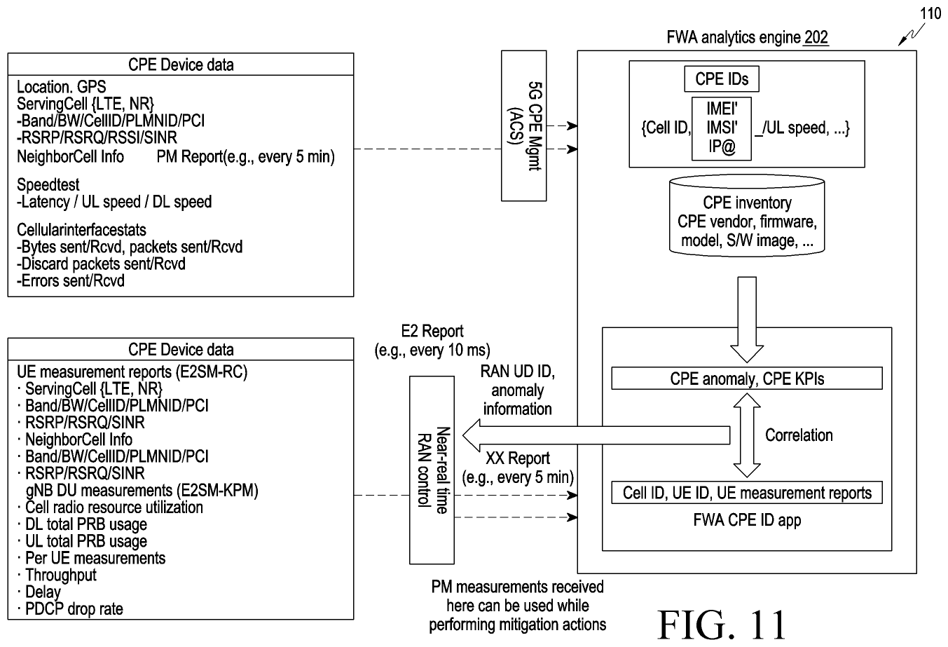

FIG. 11 is a diagram illustrating an example scenario (1100) in which KPI and measurement details are depicted, according to various embodiments. The possible KPIs which may be collected from the CPE (102a-102n) as well RAN which may be used for correlations. From the CPE (102a-102n), the KPIs are collected in the form of performance management (PM) report after every 5 minutes. From the RAN, it may be collected as E2 data and sent in a E2 report after every 10 milliseconds (ms).

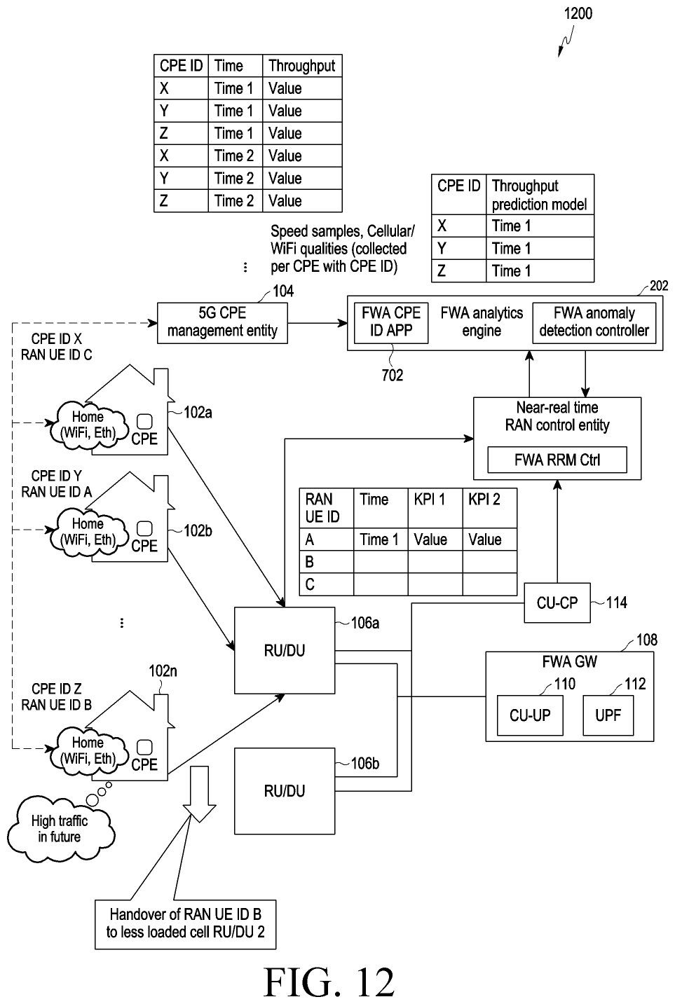

FIG. 12 is a diagram illustrating an example scenario (1200) in which the network apparatus (500) optimizes the performance of the CPE in the wireless network during a forced handover, according to various embodiments.

In the FWA analytics engine (202), the FWA CPE ID application (702) runs periodic offline processing loop for creating and updating the CPE ID to the RAN UE ID (as explained in FIG. 7 and FIG. 8). The CPE prediction model training is performed and trained models are created. It may also provide per CPE traffic predictions to the RAN for optimal mitigation solutions.

In the FWA analytics engine (202), the FWA anomaly detection controller (540a) identifies which CPE is a problematic CPE using a CPE management server data and CPE SLA information. Further, the FWA anomaly detection controller (540a) retrieves the RAN UE ID corresponding to the CPE ID updated by the FWA CPE ID application (702). The FWA anomaly detection controller (540a) will also retrieve the CPE prediction models if the CPE assurance use case based predictions is used.

Further, the FWA anomaly detection controller (540a) identifies which RAN node/Near real time control which has control over the selected CPE using the RAN UE ID. Further, the FWA anomaly detection controller (540a) obtains the information from the CPE stats connected cell information or mapping of the RAN UE ID to the RAN node/Near real time control. Further, the FWA anomaly detection controller (540a) provides the CPE anomaly towards the correct RAN node/Near real time control along with RAN UE ID to trigger targeted mitigation solutions

In the Near-RT RIC, a FWA RRM control application will use the RAN UE ID, anomaly information and future predictions of multiple CPEs/UEs. Based on the RAN UE ID, the anomaly information and the future predictions of multiple CPEs/UEs, and upon determining the mitigation solution is forced handover then, the FWA RRM Ctrl application will trigger forced handover for the anomaly RAN UE or other RAN UEs towards other less loaded cells in the wireless network which have connectivity with sufficient signal strength towards the CPE/UE.

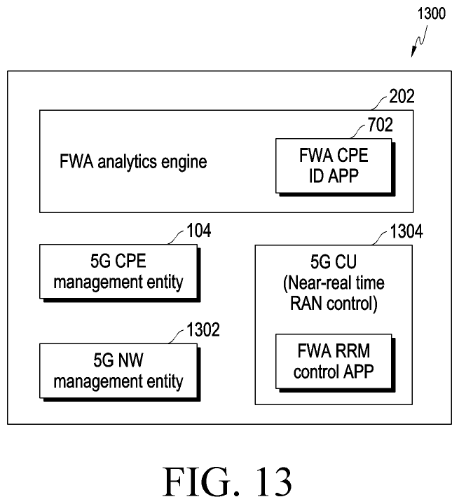

FIG. 13 is a diagram illustrating an example scenario (1300) in which the network apparatus (500) optimizes the performance of the CPE in a non O-RAN deployment, according to various embodiments. For the non-ORAN kind of deployments, the disclosed method may be implemented in a part of independent server or management servers (e.g. self-organized network (SON) server or the like).

The non O-RAN deployment includes the FWA analytics engine (202), the FWA CPE ID application (702), the 5G CPE management entity (104), a 5G network management entity (1302), a 5G CU (1304), and a FWA RRM control application. The FWA RRM control application is running in the 5G CU (1304). The FWA analytics engine (202) communicates with the FWA CPE ID application (702), the 5G CPE management entity (104), the 5G network management entity (1302), and the 5G CU (1304). The operations and functions of the FWA analytics engine (202), the FWA CPE ID application (702), and the 5G CPE management entity (104) are already explained.

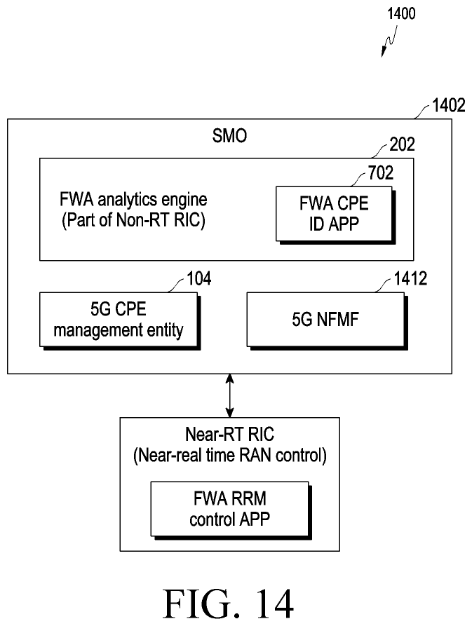

FIG. 14 is a block diagram illustrating an example scenario (1400) in which the network apparatus (500) optimizes the performance of the CPE in a O-RAN deployment, according to various embodiments. For the ORAN type of solutions, the disclosed method may be used to implement in Service Management and Orchestration (SMO) (1402).

The SMO (1402) includes the FWA analytics engine (202), the FWA CPE ID application (702), the 5G CPE management entity (104), a 5G NFMF (1412). The FWA analytics engine (202) is a part of a Non-RT RIC in the SMO (1402). The operations and functions of the FWA analytics engine (202), the FWA CPE ID application (702), and the 5G CPE management entity (104) are already explained. For the sake of brevity, we are not explaining again. The SMO (1402) communicates with a Near-RT RIC in which a FWA RRM control application is running.

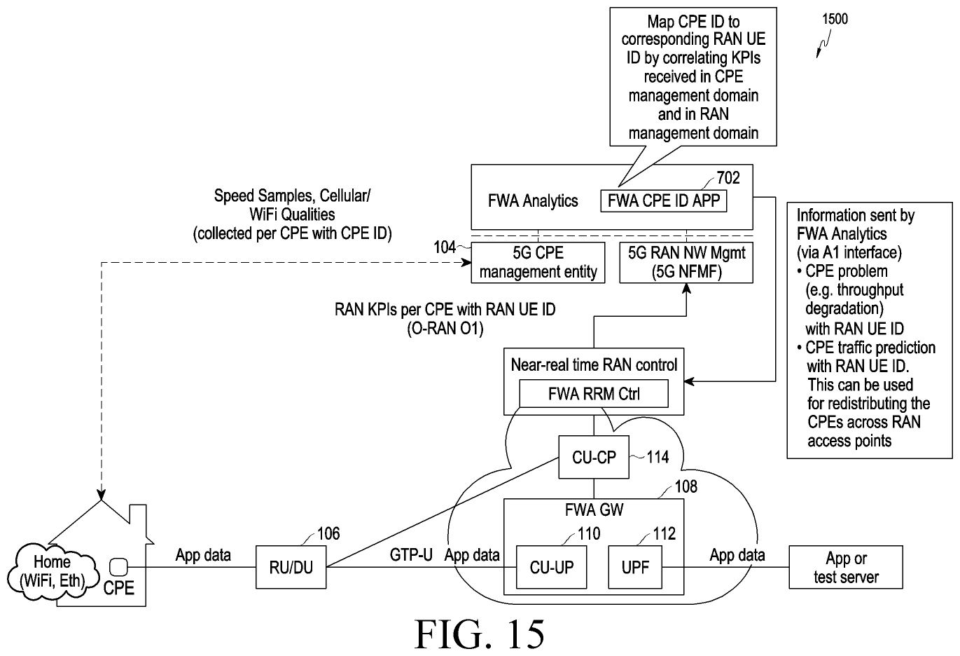

FIG. 15 is a diagram illustrating an example scenario (1500) in which the network apparatus (500) optimizes the performance of the CPE in the wireless network, according to various embodiments. Based on the disclosed method, the FWA CPE ID app (702) may map the CPE ID to the corresponding RAN UE ID by correlating KPIs received in the CPE management domain and the RAN management domain. Based on the mapping, the network apparatus (500) applies the action. The action may be, for example, but not limited to the forced handover of the CPE to the less loaded cell in the RAN node which have good connectivity with sufficient signal strength towards the CPE, the throughput enhancement, and the traffic reduction.

The various example embodiments disclosed herein may be implemented through at least one software program running on at least one hardware device and performing network management functions to control the elements. The elements may be at least one of a hardware device, or a combination of hardware device and software module.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) disclosed herein may be used in conjunction with any other embodiment(s) disclosed herein.

What is claimed is:

1. A method for optimizing a performance of a customer premises equipment (CPE) in a wireless network, comprising:
receiving, by a network apparatus, first measurement information from at least one customer premises equipment (CPE);
receiving, by the network apparatus, second measurement information from at least one radio access node (RAN) node;
detecting, by the network apparatus, whether a performance associated with at least one CPE is degraded based on the first measurement information;
identifying, by the network apparatus, a RAN user equipment identifier (UE ID) for the at least one CPE whose performance is degraded by correlating the first measurement information received and the second measurement information; and
applying, by the network apparatus, an action based on the identified RAN UE ID.

2. The method of claim 1, wherein the action comprises at least one of a forced handover of the CPE to a less loaded cell in the RAN node having a connectivity with sufficient signal strength towards the at least one CPE, a throughput enhancement, and a traffic reduction.

3. The method of claim 1, wherein each of the first measurement information and the second measurement information comprises at least one of a latency, a reference signal received power (RSRP), a signal to interference noise ratio (SINR), a reference signal received quality, (RSRQ), a channel quality indicator (CQI), throughput, and a received signal strength indicator (RSSI).

4. The method of claim 1, wherein correlating, by the network apparatus, the first measurement information and the second measurement information comprises:
correlating the first measurement information comprising at least one key performance indicator (KPI) and second measurement information comprising at least one KPI; and
dynamically creating a mapping between the first measurement information comprising the at least one KPI and the second measurement information comprising the at least one KPI.

5. The method of claim 1, wherein the first measurement information and the second measurement information are correlated using a correlation technique comprising at least one of a Pearson correlation technique, Spearman correlation technique, Kendal-Tau correlation technique and dynamic time warping (DTW) technique.

6. The method of claim 1, wherein a CPE ID to the RAN UE ID mapping is created and updated in a periodic manner over an offline mode.

7. The method of claim 1, wherein the network apparatus provides at least one CPE prediction model to assist for applying the action based on the identified RAN UE ID.

8. A network apparatus, comprising:
at least one processor;
a memory; and
a customer premises equipment (CPE) performance controller comprising circuitry, coupled with at least one processor and the memory, configured to:
receive first measurement information from at least one CPE;
receive second measurement information from at least one radio access node (RAN) node;
detect whether a performance associated with at least one CPE is degraded based on the first measurement information;
identify a RAN user equipment identifier (UE ID) for the at least one CPE having a performance degraded based on correlating the first measurement information and the second measurement information; and
apply an action based on the identified RAN UE ID.

9. The network apparatus of claim 8, wherein the action comprises at least one of: a forced handover of the CPE to a less loaded cell in the RAN node having connectivity with sufficient signal strength towards the at least one CPE, a throughput enhancement, and a traffic reduction.

10. The network apparatus of claim 9, wherein each of the first measurement information and the second measurement information comprises at least one of a latency, a reference signal received power (RSRP), a signal to interference noise ratio (SINR), a reference signal received quality, (RSRQ), a channel quality indicator (CQI), throughput, and a received signal strength indicator (RSSI).

11. The network apparatus of claim 9, further comprises correlating the first measurement information and the second measurement information, the correlating comprising:
correlating the first measurement information comprising at least one key performance indicator (KPI) and the second measurement information comprising at least one KPI; and
dynamically creating a mapping between the first measurement information comprising the at least one KPI and the second measurement information comprising the at least one KPI.

12. The network apparatus of claim 9, wherein the first measurement information and the second measurement information are correlated using a correlation technique, wherein the correlation technique comprises at least one of a Pearson correlation technique, Spearman correlation technique, Kendal-Tau correlation technique and dynamic time warping (DTW) technique.

13. The network apparatus of claim 9, wherein a CPE ID to the RAN UE ID mapping is created and updated in a periodic manner over an offline mode.

14. The network apparatus of claim 9, wherein the CPE performance controller is configured to provide at least one CPE prediction model to assist in applying the action based on the identified RAN UE ID.

15. One or more non-transitory computer-readable storage media storing computer-executable instructions that, when executed by at least one processor of a network apparatus, cause the network apparatus to perform operations, the operations comprising:
receiving, by a network apparatus, first measurement information from at least one customer premises equipment (CPE);
receiving, by the network apparatus, second measurement information from at least one radio access node (RAN) node;
detecting, by the network apparatus, whether a performance associated with at least one CPE is degraded based on the first measurement information;
identifying, by the network apparatus, a RAN user equipment identifier (UE ID) for the at least one CPE whose performance is degraded by correlating the first measurement information received and the second measurement information; and
applying, by the network apparatus, an action based on the identified RAN UE ID.

16. The one or more non-transitory computer-readable storage media of claim 15, wherein the action comprises at least one of a forced handover of the CPE to a less loaded cell in the RAN node having a connectivity with sufficient signal strength towards the at least one CPE, a throughput enhancement, and a traffic reduction.

17. The one or more non-transitory computer-readable storage media of claim 15, wherein correlating, by the network apparatus, the first measurement information and the second measurement information comprises:
correlating the first measurement information comprising at least one key performance indicator (KPI) and second measurement information comprising at least one KPI; and
dynamically creating a mapping between the first measurement information comprising the at least one KPI and the second measurement information comprising the at least one KPI.

18. The one or more non-transitory computer-readable storage media of claim 15, wherein the first measurement information and the second measurement information are correlated using a correlation technique comprising at least one of a Pearson correlation technique, Spearman correlation technique, Kendal-Tau correlation technique and dynamic time warping (DTW) technique.

19. The one or more non-transitory computer-readable storage media of claim 15, wherein a CPE ID to the RAN UE ID mapping is created and updated in a periodic manner over an offline mode.

20. The one or more non-transitory computer-readable storage media of claim 15, wherein the network apparatus provides at least one CPE prediction model to assist for applying the action based on the identified RAN UE ID.
